(19) United States
(12) Patent Application Publication
(10) Pub. No.: US 2009/0009904 A1
(43) Pub. Date: Jan. 8, 2009

(54) Method for forming servo pattern and magnetic disk drive

(76) Inventors: Kei Yasuna, Kanagawa (JP); Kohji Takasaki, Kanagawa (JP); Fuminori Sai, Kanagawa (JP); Makoto Takase, Kanagawa (JP); Tomoyuki Oyama, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/215,260

(22) Filed: Jun. 25, 2008

(30) Foreign Application Priority Data
Jun. 26, 2007 (JP) 2007-167723

(51) Int. Cl. G11B 21/02

(52) U.S. Cl. 360/75; G9B/21.003

(57) ABSTRACT

Embodiments of the present invention provide a method of forming an initial servo-pattern for self servowrite, insusceptible to constraints of an output resolution of a driver circuit for driving an actuator, and a dynamic range. According to one embodiment, a cluster pattern made up of pattern blocks, each including a burst pattern, is written by use of a write element by pressing a head-support mechanism to a crash-stop, and a pattern block is newly written with a read element in states of being positioned at an inner peripheral side edge of the cluster pattern, an outer peripheral side edge thereof, and the center of two burst patterns included in the cluster pattern, respectively, thereby increasing a width of the cluster patterns in stages, so that an initial servo pattern for use in a propagation action is formed.

### CROSS-REFERENCE TO RELATED APPLICATION

The instant nonprovisional patent application claims priority to Japanese Patent Application No. 2007-167723 filed Jun. 26, 2007 and which is incorporated by reference in its entirety herein for all purposes.

### BACKGROUND OF THE INVENTION

With a magnetic disk drive, signals for detection of a head position, in numbers ranging from scores to not less than a hundred, per one cycle, are continuously disposed across a whole region in a radial direction on a recording surface (hereinafter referred to as a servo pattern). Work for writing the servo pattern is called servo write, and is generally executed in a process for production of a magnetic disk drive. As one form for executing the servo-write, there is a method called self servowrite, whereby the magnetic disk drive executes positioning of a head, and timing control by reading a pattern written by itself to thereby write the servo pattern.

In the self servowrite, there is repeatedly executed an action (called a self-propagation action) for spreading the pattern by writing a new track while executing the positioning of the head by reading the pattern written by the magnetic disk drive itself. Accordingly, a write element and a read element are disposed on a slider face of a head so as to be radially offset from each other such that a pattern formed by the write element at a stage can be read by the read element later on.

At the initial stage of the self servowrite, however, nothing is written on a recording face of a disk, and consequently, with the disk as it is, a pattern written to the disk by the write element cannot be read by the read element. For this reason, it is necessary to form a pattern (hereinafter referred to as an initial pattern) enabling the self-propagation action to be executed by means of any method at a stage prior to the start of the self-propagation action. With the self-propagation action, because positioning control of the head, in a radial direction, is executed on the basis of a pattern as-read, it is required that the initial pattern is capable of detecting the positioning of the head, in the radial direction, by reading itself, and a pattern formation range is continuously formed over a wide range (in general, corresponding to several tracks) sufficient to cover both the read element, and the write element.

In Japanese Patent Publication No. 2004-185682 (“Patent Document 1”), in order to write such a pattern as described, there is disclosed a method whereby bias current in a given direction is applied to an actuator supporting a head at the stage of starting the self servowrite to thereby firmly press the actuator to an inner peripheral crash-stop so as to hold a head position, and in that state, the current applied to the actuator is gradually decreased, thereby writing the pattern while moving the head little by little toward the outer periphery. With this method, by taking advantage of pressing of the actuator by the agency of the bias current, and elastic deformation of the crash-stop, patterns spread in a radial direction can be written even at a stage where a read signal cannot read.

The above-described method of executing fine shifting of the head in order to write the initial pattern by adjustment of the magnitude of the bias current is based on the premise that an output resolution of a driver circuit for driving the actuator, and a dynamic range can be sufficiently secured against a track pitch of the servo pattern to be written. However, with the latest magnetic disk drive having a high recording density, the width of one track has since decreased to a level as small as 200 nm or less, so that there is no denying the possibility that with the method using the adjustment of the magnitude of the bias current, described as above, if future enhancement in track density is taken into consideration, a problem of insufficient resolution of the driver circuit will arise. Further, there is also a possibility of occurrence of problems such as a change in bias force, due to variation in temperature, and so forth, inability of securing reproducibility of a relationship between applied current and a head position, due to variation in properties of the crash-stop, and so forth.

There is the possibility that the dynamic range of VCM bias current becomes insufficient at the time of forming the initial pattern for the self servowrite. Further, it becomes impossible to secure the reproducibility of the relationship between applied current and a head position, due to variation in properties of the VCM, and the crash-stop, attributable to variation in temperature.

### BRIEF SUMMARY OF THE INVENTION

Embodiments of the present invention provide a method of forming an initial servo-pattern for self servowrite, insusceptible to constraints of an output resolution of a driver circuit for driving an actuator, and a dynamic range. According to the embodiment of FIG. 1, a cluster pattern 104 made up of pattern blocks, each including a burst pattern, is written by use of a write element 203a by pressing a head-support mechanism to a crash-stop, and a pattern block is newly written with a read element 203b in states of being positioned at an inner peripheral side edge of the cluster pattern 104, an outer peripheral side edge thereof, and the center of two burst patterns 102 included in the cluster pattern, respectively, thereby increasing a width of the cluster patterns in stages, so that an initial servo pattern for use in a propagation action is formed.

### BRIEF DESCRIPTION OF THE DRAWINGS

FIG. 1 is a view showing an initial pattern of self servowrite according to an embodiment of the present invention.

FIG. 2A is an external view of a magnetic disk drive according to an embodiment of the present invention, in its state with a cover thereof removed.

FIG. 2B is a functional block diagram of the magnetic disk drive according to an embodiment of the present invention.

FIG. 3 is a view showing a format of a servo-trigger block (pattern block).

FIG. 4 is a view showing a pattern layout of a cluster pattern, and read waveforms.

FIG. 5 is a flow chart showing a series of steps of a procedure for forming the initial pattern.

FIGS. 6(a) and 6(b) are views showing a relationship between a radial position of a read element when reading the cluster pattern, and a waveform amplitude as obtained.

FIG. 7 is a view showing an operation for writing a third cluster pattern while executing positioning at a second cluster pattern.

FIG. 8 is a view showing a relationship between a radial position of the read element when reading the cluster pattern, and waveform amplitudes as obtained.

FIGS. 9(a) and 9(b) are views showing a basic concept, based on which adjustment is made on a difference between the waveform amplitude target for positioning on an inner peripheral edge, and that on an outer peripheral edge on the basis of a way in which bursts of the third cluster pattern overlap each other.

FIG. 10 is a flow chart showing a procedure for a self servowrite operation in common use.

### DETAILED DESCRIPTION OF THE INVENTION

Embodiments of the present invention relate to a magnetic disk drive, and in particular, to self servowrite for writing servo signals without the use of an external actuator, and a clock head.

It is an object of embodiments of the present invention to provide a method of forming an initial servo-pattern for self servowrite insusceptible to constraints of an output resolution of a driver circuit for driving an actuator, and a dynamic range.

Another object of embodiments of the present invention is to provide a magnetic disk drive capable of implementing self servowrite by a feedback operation on the basis of a read waveform as-read by a read element.

A feature of embodiments of the present invention lies in that instead of holding a position of the magnetic head by applying a given bias current at the stage of forming the initial servo-pattern for the self servowrite, a relative position of the magnetic head against the pattern written on the magnetic disk is held by dynamically adjusting current applied to the actuator by a feedback operation based on a read waveform as-read with the read element. By so doing, the initial servo-pattern for the self servowrite is formed without being subjected to the constraints of the output resolution of the driver circuit for driving the actuator, and the dynamic range.

More specifically, a method for forming a servo-pattern according to embodiments of the present invention comprises the steps of writing a cluster pattern made up of pattern blocks, each including a burst pattern, by use of a write element, at the stage of forming an initial servo pattern by pressing a head-support mechanism to a crash-stop with the use of a magnetic head having a read element offset on an inner peripheral side of the write element, and newly writing a pattern block with the read element in states of being positioned at an inner peripheral side edge of the cluster pattern, an outer peripheral side edge thereof, and the center of two burst patterns included in the cluster pattern, respectively, thereby writing a cluster pattern having pattern blocks greater by one in numbers than the pattern blocks of the cluster pattern, wherein by sequentially changing a cluster pattern for use in positioning into a newly written cluster pattern thereafter, an operation for writing a cluster pattern is repeated, and a width of the cluster patterns is increased in stages, thereby forming the initial servo pattern for use in a propagation action.

A magnetic disk drive according to embodiments of the present invention comprises a magnetic disk, a magnetic head having a read element offset on an inner peripheral side of a write element, and a control circuit for controlling an operation for positioning of the magnetic head against the magnetic disk, and write/read operations of the magnetic head, wherein a cluster pattern made up of pattern blocks, each including a burst pattern, is written by use of the write element at the stage of forming an initial servo pattern by pressing a head-support mechanism to a crash-stop under control by the control circuit, a pattern block is newly written with the read element in states of being positioned at an inner peripheral side edge of the cluster pattern, an outer peripheral side edge thereof, and the center of two burst patterns included in the cluster pattern, respectively, to thereby write a cluster pattern having pattern blocks greater by one in numbers than the pattern blocks of the cluster pattern, a cluster pattern for use in positioning is sequentially changed into a newly written cluster pattern thereafter, an operation for writing the cluster pattern is repeated to thereby increase a width of the cluster patterns in stages, and the initial servo pattern for use in a propagation action is formed.

With the embodiments of the present invention, it is possible to provide the method of forming the initial servo-pattern for self servowrite insusceptible to the constraints of the output resolution of the driver circuit for driving the actuator, and the dynamic range.

Further, it is possible to provide the magnetic disk drive capable of implementing the self servowrite by the feedback operation on the basis of the read waveform as-read by the read element.

Described hereinafter are embodiments of a magnetic disk drive, and a method for forming a servo pattern, respectively, according to embodiments of the present invention.

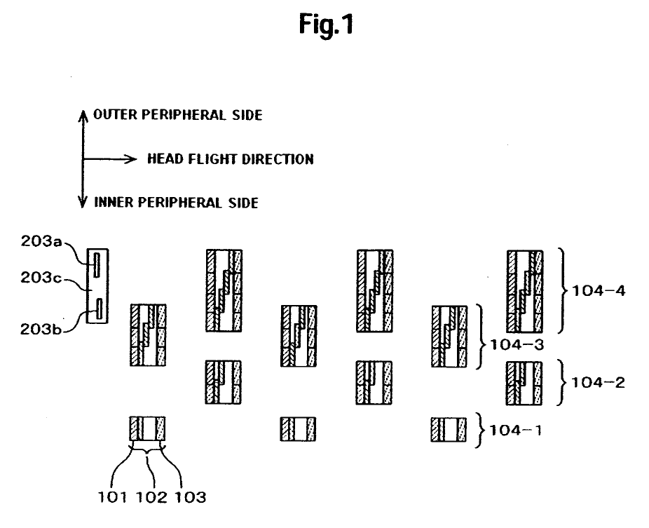

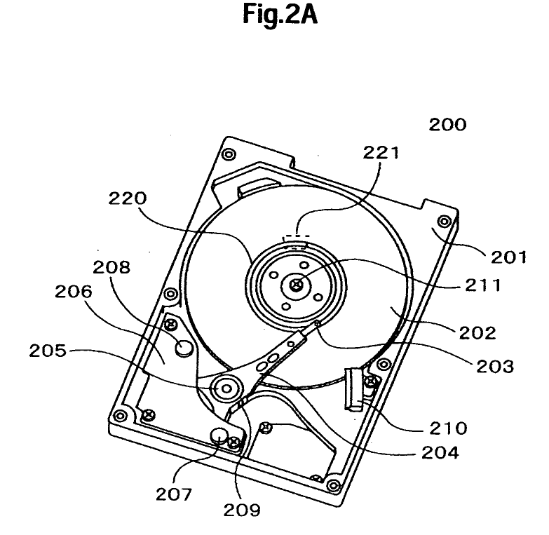

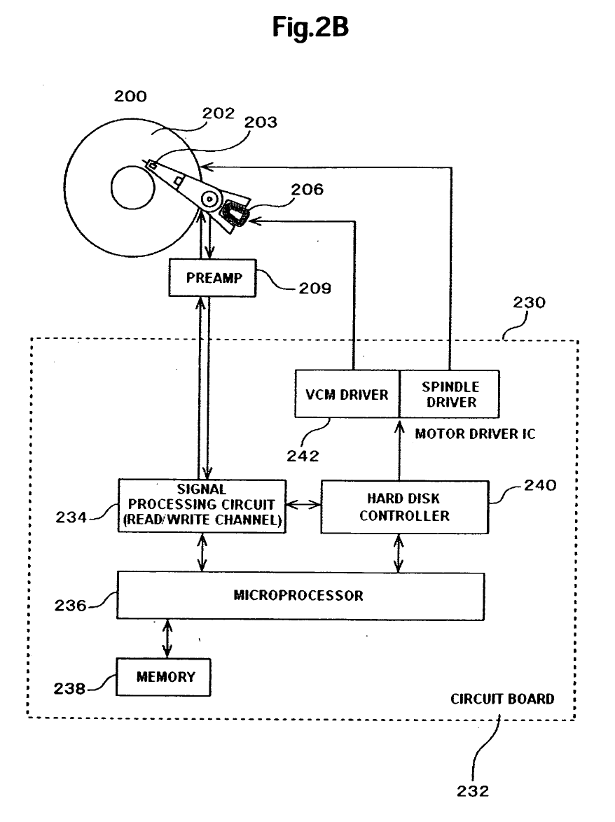

FIG. 2A is a top view showing constituent elements of the magnetic disk drive according to the embodiments of the present invention. FIG. 2A shows the magnetic disk drive in a state where a cover thereof is removed so that the constituent elements thereof can be seen with greater ease. The magnetic disk drive 200 comprises an enclosure 201, a magnetic disk 202 that is a medium for storing information, and a magnetic head 203 for writing and reading signals from the medium. The magnetic disk 202 is fitted to a rotating shaft 211 of a spindle motor so as to be rotated. As shown in FIG. 1, the magnetic head 203 has a slider 203c provided with a write element 203a and a read element 203b, and flies opposite to the magnetic disk in rotation. Reverting to FIG. 2A, the magnetic head 203 is supported by an actuator 206 through the intermediary of a head-support mechanism 204 so as to be rotatable around a pivot 205. The actuator 206 is made up of a voice coil motor (hereinafter referred to as a VCM), and generates a torque corresponding to current flowing to a coil, a movable range thereof being restricted by an inner periphery crash-stop 207 made up of an elastic body, and an outer periphery crash-stop 208 made up of an elastic body, respectively. The movable range is set to have dimensions large enough to cover a whole range for storing information on the magnetic disk 202, and the magnetic head 203 is moved to an optional position along the radius of the magnetic disk 202 in rotation, for writing information thereto, and reading information therefrom. The magnetic head 203 is driven by a preamp 209 to thereby execute write/read operations. When the write/read operations are not executed, the magnetic head 203 retreats to a ramp mechanism 210 positioned outside the magnetic disk 202, and is held in a state away at a distance from a disk face.

With the magnetic disk drive made up as above, described hereinafter is the function of a control circuit for implementing the write/read operations of the magnetic head, for writing information to, and reading information from the magnetic disk with reference to FIG. 2B. FIG. 2B is a block diagram showing the function of the control circuit 230 in charge of operating the magnetic disk drive. The control circuit 230 is mounted on a circuit board 232. In general, the circuit board 232 is mounted on the back surface of the enclosure 201 shown in FIG. 2A. The circuit board 232 is provided with a microprocessor 236, a signal processing circuit 234, a hard disk controller 240, a memory 238, and a motor driver IC 242.

An operation procedure of the magnetic disk drive 200 is written as a program to be executed by the microprocessor 236, and the program is stored in regions in the memory 238. The microprocessor 236 executes generation of a write signal against the magnetic disk 202, and demodulation of a read signal via the signal processing circuit 234. Meanwhile, the microprocessor 236 further executes control of the operation of the spindle motor via the motor driver IC 242, and control of positioning of the magnetic head by driving the VCM. The hard disk controller 240 provides the microprocessor 236 with respective accesses to peripheral functions such as the signal processing circuit 234, the motor driver IC 242, and so forth, and an access to a host computer (not shown).

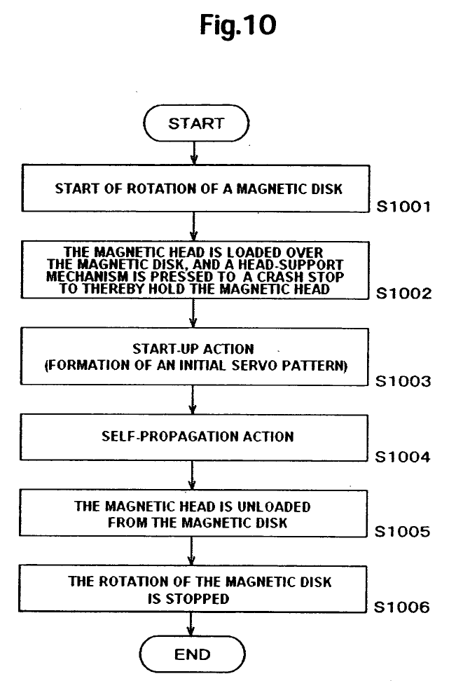

Now, a procedure for self servowrite in common use is first described with reference to FIG. 10 before describing a method for forming an initial servo-pattern necessary for starting the self-propagation action of a pattern when the magnetic disk drive 200 executes the so-called self servowrite whereby the magnetic disk drive writes the servo signal to the magnetic disk with the use of the magnetic head which the magnetic disk drive itself is provided with. With the magnetic disk drive having the magnetic disk with no pattern written thereon, the spindle motor is activated (S1001). Subsequently, the magnetic head is loaded over a surface of the magnetic disk, and bias current in an inner peripheral direction is applied to the VCM so as to press the head-support mechanism 204 to the crash stop to thereby hold the magnetic head in the vicinity of the innermost periphery of the surface of the magnetic disk (S1002). Then, a pattern is written on the surface of the magnetic disk, having no pattern written thereon, thereby forming an initial servo pattern necessary for the self-propagation action (S1003). Upon formation of the initial servo-pattern, the self-propagation action is repeatedly executed starting from the inner periphery toward the outer periphery, thereby forming a servo pattern throughout a recording surface of the magnetic disk (S1004). When the magnetic head has reached the outer periphery, and a necessary number of tracks are formed, the magnetic head is unloaded from the magnetic disk (S1005). Upon checking retrieval of the magnetic head, the spindle motor is stopped, thereby completing a servo write operation (S1006).

The method for forming the initial servo-pattern according to the embodiments of the invention relates to a startup action (S1003) among series of steps of the procedure described as above. The method has a feature lying in that patterns called cluster patterns, each having servo information, and trigger information, written so as to be connected together to have a width in a radial direction, corresponding to several steps, by aligning in phase with each other, are formed at the stage of the startup action, and a new cluster pattern, having a width spread by one step, is sequentially written while executing positioning against the respective cluster patterns to thereby form the initial servo-pattern for the self-propagation action, greater in width than an offset between the read element, and the write element (hereinafter referred to as an RF offset).

An operation for forming the initial pattern according to embodiments of the invention is described hereinafter with reference to FIGS. 1 to 7. The operation for forming the initial servo-pattern is executed with the head-support mechanism 204 in such a state as pressed to the inner peripheral crash stop 207 in FIG. 2A, that is, with the magnetic head 203 in such a state as positioned in the innermost peripheral region 220 of the magnetic disk 202.

FIG. 1 is a view showing a layout of the cluster patterns written in the innermost peripheral region 220 in FIG. 2A, in a region 221 thereof. The cluster pattern is made up of sectors in numbers ranging from scores to several hundreds per one cycle. The number of the sectors of the cluster pattern need not necessarily coincide with the number of sectors of a product servo pattern finally formed by the servo write action. However, with a particular embodiment of mounting according to the present invention, the number of the sectors of the initial servo pattern is assumed to be the same as the number of the sectors of the product servo pattern. FIG. 1 shows the cluster patterns corresponding to three sectors among several hundreds of the cluster patterns.

The cluster patterns are sequentially written by increasing the number of stages, such as a first stage, a second stage, and so forth, starting from the inner peripheral side. First, upon writing a first cluster pattern 104-1, positioning of the read element 203b on the top of the first cluster pattern 104-1 is executed, thereby writing a second cluster pattern 104-2. The second cluster pattern 104-2 is positioned on the outer peripheral side further by the RF offset as seen from the first cluster pattern 104-1. At this point in time, writing is executed with the read element 203b at two sites slightly off from the center of the pattern, the cluster pattern in the second stage is formed from the cluster pattern in the first stage. Since writing is executed by triggering against one pattern, consistency in phase of the cluster pattern in the second stage is secured. Similarly, by executing positioning of the read element 203b on the top of the second cluster pattern 104-2, a third cluster pattern 104-3 is written, and by executing positioning of the read element 203b on the top of the third cluster pattern 104-3, a fourth cluster pattern 104-4 is written. By sequentially increasing the number of the stages of the cluster patterns, the pattern spreads in width, and in the case of the embodiment shown in FIG. 1, a pattern capable of covering a width corresponding to the RF offset is formed upon the formation of the fourth cluster pattern 104-4. By so doing, the pattern can be used as the initial servo pattern for the self-propagation action.

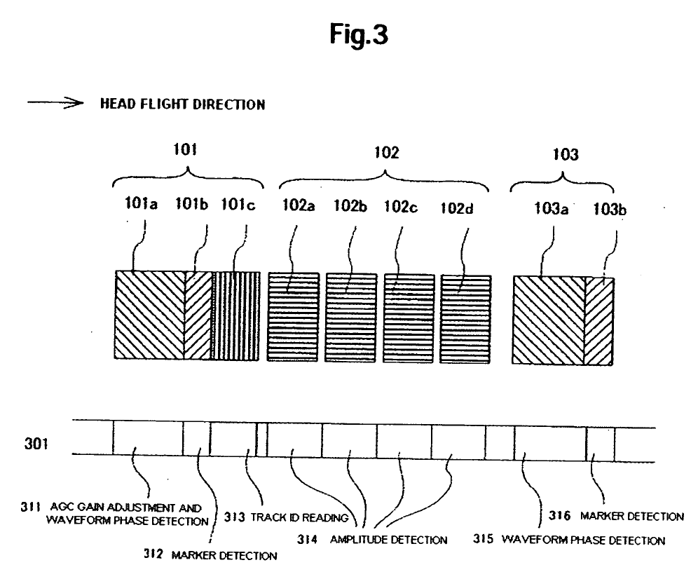

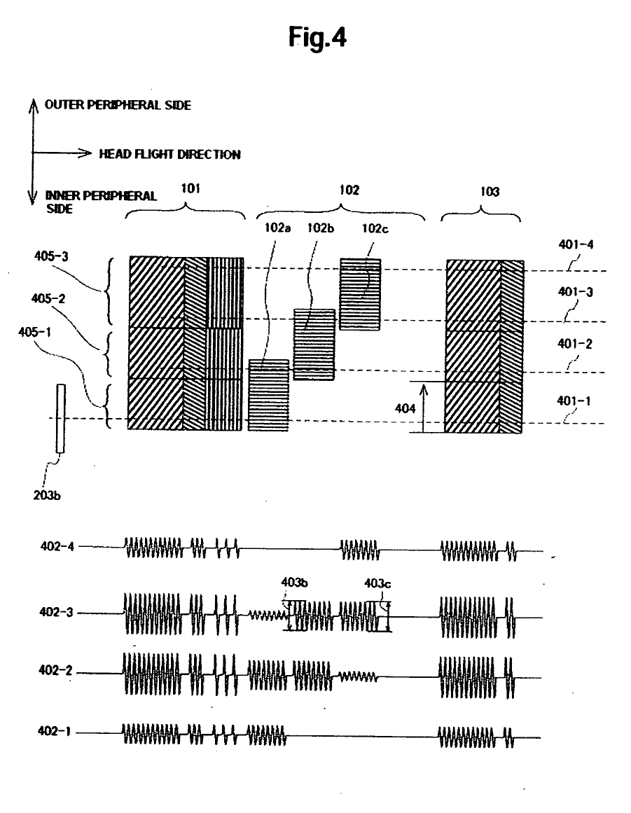

Further, a makeup of the cluster pattern is described with reference to FIGS. 3 and 4. The cluster pattern is made up by combining pattern blocks, called servo-trigger blocks shown in FIG. 3, with each other. The servo-trigger block (hereinafter referred to as the pattern block) comprises a servo block made up of a servo information unit 101, and a burst 102, and a trigger block 103. Shown at 301 is an operation executed by the signal processing circuit 234 when reading respective patterns of the servo block, and the trigger block.

At the head of the servo information unit 101, there are provided a preamble 101a for an automatic gain adjustment (Automatic Gain Control: hereinafter referred to as AGC), and detection of a waveform phase, and a servo address marker 101b continuing thereto, to be used for adjustment of a gain of an amplifier in an AGC circuit such that an amplitude of a waveform will be at an adequate level at the time of reading, and for aligning a detector in phase with the waveform. There is provided a track ID code 101c behind the address marker 101b. Behind the servo information unit 101, the burst 102 for detecting a radial position of the head is disposed. A burst pattern is divided into four segments in a circumferential direction, that is, 102a (burst A), 102b (burst B), 102c (burst C), and 102d (burst D), and the bursts in the respective segments, each having a width of the write element 203a, are disposed so as to be offset from each other in the radial direction of the disk.

The trigger block 103 comprises a trigger field 103a for detection of a waveform phase, and a trigger marker 103b. The signal processing circuit 234 can accurately synchronize with the waveform phase of the pattern written on the magnetic disk by reading the trigger block 103. Further, according to embodiments of the present invention, the trigger block 103 is independently disposed behind the servo block, however, if the hard disk controller 240 corresponds to the signal processing circuit 234, the trigger block 103 may be disposed in reverse order thereto, or if the function for synchronization with the waveform phase of the pattern can be shared between the trigger block 103 and the address marker 101b, the trigger block 103 may be omitted by leaving out the address marker 101b only.

A configuration for forming the cluster pattern by combining the pattern blocks shown in FIG. 3 with each other is described hereinafter with reference to FIG. 4. FIG. 4 shows a pattern example of the third cluster pattern 104-3 shown in FIG. 1. The third cluster pattern is formed by writing so that a pattern block 405-1 in a first stage, a pattern block 405-2 in a second stage, and a pattern block 405-3 in a third stage are shifted from each other by a predetermined shift pitch 404 in the radial direction. With the servo information unit 101, and the trigger block 103, overwriting is executed while securing consistency in waveform phase, however, with the burst 102, a segment to be written among the segments of one pattern block is only one segment among the burst A, the burst B, the burst C, and the burst D, and overwriting is not executed in the segments other than the one segment. By changing over the segment to be written when writing the respective pattern blocks, a stairway-like pattern as shown in FIG. 4 is formed. Since the overwriting is not executed in the segments other than the segment to be written, a pattern formed in the burst 102 has the same width as that of the write element 203a.

When writing the fourth cluster pattern 104-4 from the third cluster pattern 104-3, a new pattern block is formed by executing positioning of the read element 203b at four sites of an inner peripheral edge 401-1, the center 401-2 of the burst A, and the burst B, the center 401-3 of the burst B and the burst C, and an outer peripheral edge 401-4.

Shown at 402-1, 402-2, 402-3, and 402-4 are respective waveforms of patterns as read when the read element 203b is at respective radial positions 401-1, 401-2, 401-3, and 401-4. A positioning action will be described in detail later in the present specification, but to take the case of the positioning at the center 401-3 between the burst B and the burst C as an example, the positioning is implemented by the microprocessor 236 adjusting current applied to the VCM 206 on the basis of a difference between amplitudes 403b, 403c in the burst.

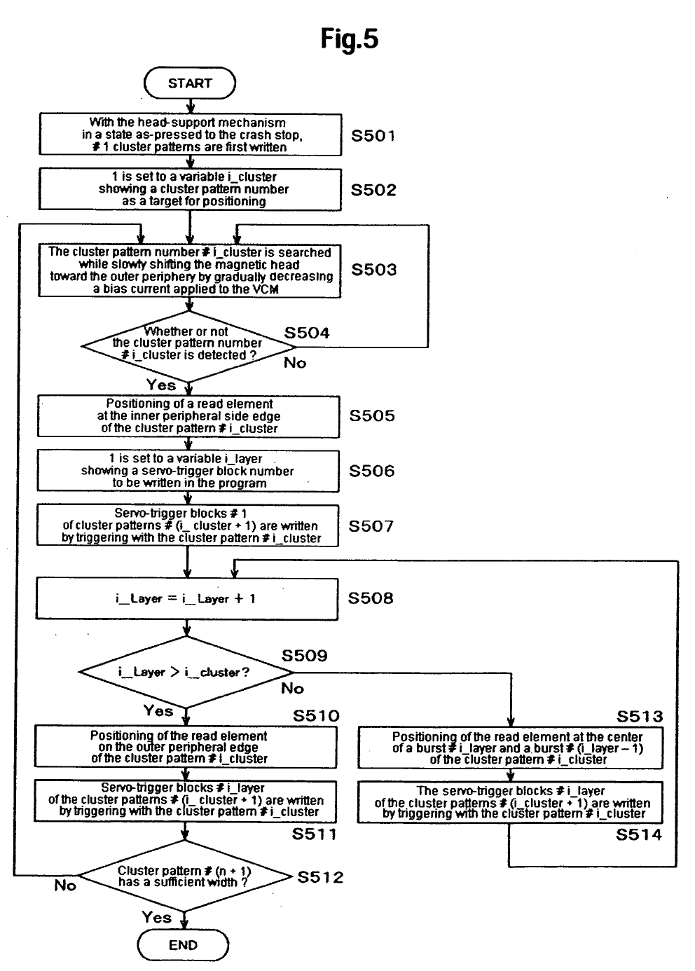

FIG. 5 shows a series of steps of a procedure from sequentially forming the cluster pattern shown in FIG. 4 until the formation of the initial servo pattern for the self-propagation action. Upon start of a self servowrite operation, the magnetic disk drive 200 rotates the magnetic disk 202, and the bias current in the inner peripheral direction is applied to the VCM 206 so as to press the head-support mechanism 204 to the crash stop 207 to thereby hold the magnetic head 203 at a position in the vicinity of the innermost periphery of the surface of the magnetic disk. With the magnetic head 203 held in that state, the first cluster patterns 104-1 are first written per one cycle of the magnetic disk 202 (step S501). Upon completion of writing, 1 is set to a variable i_cluster for retaining a cluster pattern number as a target for positioning, in a program of the microprocessor 236 (step S502), and the magnetic head 203 is slowly shifted toward the outer periphery while gradually decreasing the bias current applied to the VCM (step S503). The signal processing circuit 234 is kept active in search mode at this stage, and upon the read element 203b arriving over a written pattern so as to be able to read a waveform (step S504), the procedure proceeds to a positioning action toward the inner peripheral side edge (step S505). Upon completion of the positioning at the inner peripheral side edge, 1 is set to a variable i_layer for retaining a servo-trigger block number to be written in the program (step S506), and by triggering with the first cluster patterns, first pattern blocks of the second cluster patterns are written per one cycle (step S507).

Upon completion of writing, i_layer is incremented by one (step S508), thereby determining which of i_layer, and i_cluster is greater in value (step S509). If i_layer is smaller in value, the positioning is made at the center of the two bursts (step S513), thereby writing an i_layer-th servo-trigger block (step S514).

On the other hand, if i_layer is greater in value, the positioning at the outer peripheral edge is executed (step S510), thereby writing an i_layer-th pattern block (step S511). Upon completion of the writing, checking is executed on whether or not the cluster pattern formed at the outer peripheral edge has spread to a degree sufficient to enable the self-propagation action to be started (step S512). Such checking can be executed by seeing whether or not the newly written cluster pattern at the position of the outer peripheral edge after the completion of the writing can be read, and if yes, by detecting position information obtainable from the newly written cluster pattern to thereby find out an extent to which the newly written cluster pattern overlaps the cluster pattern at the position already determined, along the radial direction. If such overlapping is found sufficient, the newly written cluster pattern can be used as the initial pattern for the self-propagation action, so that a forming operation is completed, whereupon the procedure proceeds to the next step. On the other hand, if an overlapping width is found insufficient, the procedure reverts to the step S503, and a target for the positioning is changed to the cluster pattern previously written, whereupon operations from the step S503 to the step S514 are repeated to thereby record a new cluster pattern.

At the present stage as described, since i_cluster is 1 while i_layer is 2 in the step S509, positioning at the outer peripheral edge is executed, thereby writing a 12th pattern block of the second cluster pattern. At a point in time when the writing is completed, the first and second cluster patterns do not overlap each other in the radial direction, so that the procedure reverts to the step S503 to execute positioning at the second cluster pattern 104-2, thereby executing an operation for writing the third cluster pattern 104-3. Thereafter, an operation for similarly writing a new cluster pattern is repeated, and an operation for forming the initial pattern is completed at a point in time when overlapping between the cluster patterns is obtained in the step S512.

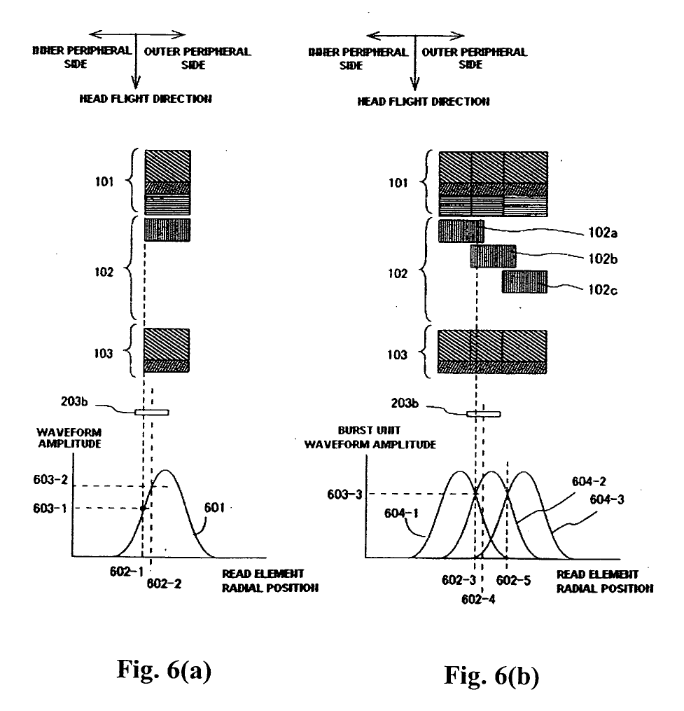

Next, there are described hereinafter operations for positioning toward the cluster patterns, executed in the steps S505, S510, and S513, respectively, in FIG. 5, with reference to FIGS. 6(a) and 6(b). The operations for positioning at the edges, executed in the steps S505, S510, respectively, are implemented by giving target values to waveform amplitudes, respectively, and feeding back a deviation of each of the present waveform amplitude values from each of the target values.

FIG. 6(a) is a view showing a state in which a read waveform amplitude undergoes a change depending on a relationship between the first cluster pattern and the read element when the read element passes over the pattern. The amplitude of the waveform of the pattern read by the read element will have a profile shown at 601 depending on a positional relationship between the read element 203b, and the pattern. However, when reading a pattern with a width corresponding to several tracks at most, as in the case of the cluster pattern, a gain of the AGC circuit, at the edge, will vary from that at the center, so that, in order to obtain a relationship of the read waveform amplitude against a read position, as indicated at 601, either the amplitude of the burst is detected by fixing the gain of the AGC circuit, or the reciprocal of the gain of the AGC circuit after adjustment is used as a substitute of the waveform amplitude. In the following description, it is assumed that the reciprocal of the gain of the AGC circuit is used.

In the case where the positioning of the read element 203b at a position of the inner peripheral side edge 602-1 is executed in a state of an amplitude profile indicated at 601 in FIG. 6(a) being obtained, a target value of a waveform amplitude is set to 603-1. If the read element 203b is at a position 602-2 even though deviated from a target position, a waveform amplitude will be at 603-2, greater in value than the target value 603-1. The waveform amplitude obtained on a sector-by-sector-basis is monitored, and if the amplitude is found large, the VCM current is increased to thereby shift the read element 203b toward the inner periphery. On the other hand, if the waveform amplitude is found smaller in value than the target value, the VCM current is decreased to thereby shift the read element 203b toward the outer periphery. By continuously executing those operations, the read element 203b is positioned at the position of the inner peripheral side edge 602-1.

Updating of an output current value of the VCM may be executed on the sector-by-sector-basis, however, since the head-support mechanism 204 is in contact with the crash-stop 207 in this stage, there is not much change in position of the magnetic head within a time range substantially corresponding to an interval between the sectors, updating cycles may be reduced without any problem.

In the case of positioning at the outer peripheral edge, the positioning can be implemented by the same operations as described above although there has to be a change in deviation from the target value, and in polarity for causing the VCM current to undergo variation. In FIG. 6(a), there is shown an example where only one burst exists, however, it is a slope of the edge of an amplitude profile that is important, so that the basically same method can be applied even to the case of a cluster pattern comprising a plurality of pattern blocks.

Meanwhile, referring to FIG. 6(b), there is described hereinafter the case where positioning of the read element is executed at the center between the two bursts, as in the step S513 shown in FIG. 5. By way of example, there is assumed an operation for executing the positioning at the center position 602-3 of the burst A (102a), and the burst B (102b). In the case of the positioning at the center of two burst patterns, a difference in amplitude between the burst A, and the burst B is monitored, thereby adjusting the VCM current so as to render the difference zero. If (the amplitude 604-1 of the burst A) (the amplitude 604-2 of the burst B) is less than 0 as in the case of the read element 203b being at a position of 602-4, the VCM current is increased, thereby moving the magnetic head toward the inner periphery, and in the case contrary thereto, the VCM current is decreased so as to shift the magnetic head toward the outer periphery to be thereby held at a position 602-3 serving as the target. By changing over the bursts, a difference therebetween being monitored, it is also possible to execute positioning at the center position 602-5 of the burst B (102b), and the burst C (102c).

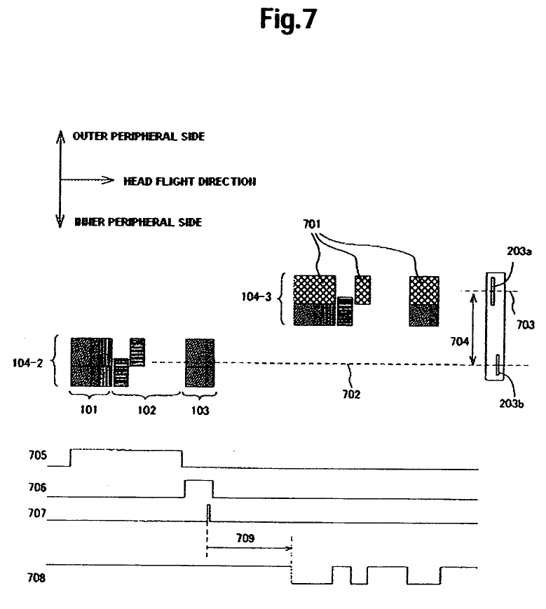

Referring to FIG. 7, there is described hereinafter an operation for writing a new cluster pattern by triggering with the cluster patterns that have been positioned, as executed in the steps S507, S511, and S514, shown in FIG. 5, respectively.

FIG. 7 is a view showing respective actions of the signal processing circuit 234, and the microprocessor 240 in connection with an operation for writing a servo-trigger blocks 701 of the third cluster pattern 104-3 at a position away by the RF offset 704 with the read element 203b kept positioned at the center 702 of the burst A, and the burst B of the second cluster pattern 104-2. While the read element 203b passes through the information unit 101, and the burst 102, the microprocessor 240 renders a servo-process enable signal 705 active, and the signal processing circuit 234 demodulates information on the position of the read element 203b. While the read element 203b passes through the trigger block 103 immediately following the burst 102, a trigger detection enable signal 706 is rendered active to thereby search for the trigger marker 103b. Upon coming into sync with the trigger marker 103b, the signal processing circuit 234 generates a trigger detection signal 707, thereby waiting for start of a write operation. With the elapse of a write delay 709 as preset, the signal processing circuit 234 renders a write gate signal 708 to be sent out to the preamp 209 active, thereby starting the write operation (the write gate signal is active at Low level). Since the burst of the new cluster pattern to be written selects only one segment out of four segments, the write gate signal 708 will be at High level in the respective segments other than the segment as selected, taking on a shape shown in the figure. The write gate signal 708 is in sync in phase with a pattern written when passing through the trigger block 103, so that consistency in waveform phase between the newly written pattern 701, and a pattern block adjacent thereto is ensured.

The initial pattern for the self-propagation action can be formed by executing a series of the operations described as above. However, in order to form the servo pattern with fewer errors in track pitch, it is also required to accurately control the shift pitch of the initial pattern.

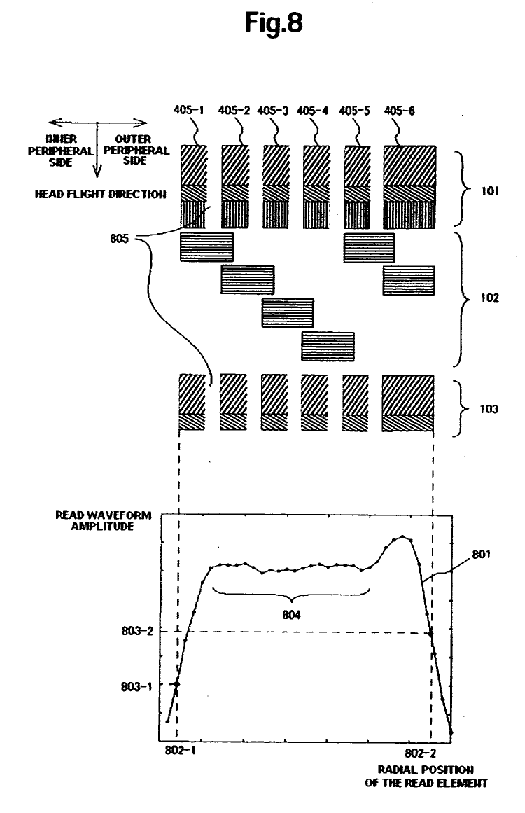

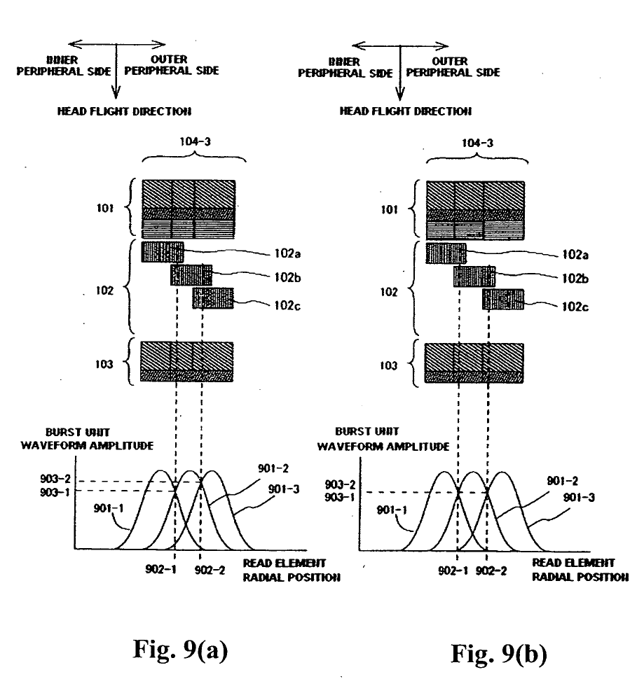

Now, a method for controlling the pitch of the initial pattern is further described with reference to FIGS. 8, and 9(a) and 9(b). FIG. 8 is view showing a state of magnetization remaining in a medium when the cluster patterns are actually written, and a profile of the read waveform amplitudes at respective radial positions when the cluster patterns are read. If the cluster patterns are formed by the method as previously described, there will remain erase bands 805 due to the effects of side erasure of the write element 203a upon overwriting because the servo information unit 101, and the trigger block 103 are written so as to be connected together by overwriting thereon. If the pattern described as above is read, the profile of the read waveform amplitudes will be as indicated at 801. While the amplitudes in a region where the pattern blocks are written so as to be connected together will decrease as indicated at 804 in the figure due to the effects of the erase bands 805, the amplitudes of the pattern blocks last written on the outer peripheral side will not decrease because overwriting is not made thereon. Accordingly, if a relative position of the pattern edge at an inner peripheral edge 802-1 against the read element 203b is rendered symmetrical to that at an outer peripheral edge 802-2, there will arise a difference in magnitude between respective target waveform amplitudes on the inner and outer peripheral sides, as indicated in the figure by the magnitude 803-1 of a target waveform amplitude on the inner peripheral side, and the magnitude 803-2 of a target waveform amplitude on the outer peripheral side. In consequence, in order to execute writing at even pitches, it is required that a target value for the waveform amplitude, necessary for executing the positioning at the edge, on the inner peripheral side, be set to differ from that on the outer peripheral side.

What is the adequate order of magnitude of a set difference between respective waveform amplitude target values on the inner periphery, and on the outer periphery is dependent on the characteristics of individual magnetic heads, so that write/read operations are preferably tried first with a magnetic head to be actually used in the process of the self servowrite operation, thereby setting the difference on the basis of results of such a trial operation.

Accordingly, referring to FIG. 9, there is described hereinafter basic concept, based on which adjustment is made on the set difference between the waveform amplitude target value on the inner periphery, and that on the outer periphery. FIG. 9 is a view showing a profile of burst amplitudes at the third cluster pattern 104-3. Whether a set difference between respective waveform amplitude target values is adequate or not can be checked at a stage where the third cluster pattern is formed.

For example, if a pre-set difference between the respective waveform target values is too large, a position determined on the basis of the edge on the outer peripheral side will end up on a side of the pattern, inner than the inner side edge thereof. An example of such a case is shown in FIG. 9(a). By implementing positioning of the read element at a position 902-1 where a burst A amplitude is equal to a burst B amplitude on the third cluster pattern, an amplitude value 903-1 is obtained. If an amplitude value 903-2 at a position 902-2 where the burst B amplitude is similarly equal to a burst C amplitude is measured to thereby compare both the amplitude values with each other, the amplitude value 903-2 is found greater in this case. By measuring a difference between the amplitude value 903-1 and the amplitude value 903-2, it is possible to determine whether the set difference between the respective waveform amplitude target values on the inner and outer peripheries has been greater or smaller than the adequate value.

In the case of executing the above-described operation in the process of forming the initial pattern, the cluster patterns up to the third cluster pattern are formed by use of a pre-set initial value to thereby compare the amplitude value 903-1 with the amplitude value 903-2, and if a difference therebetween is found inadequate, the difference between the respective waveform amplitude target values on the inner and outer peripheries is adjusted on the basis of results of determination to thereby erase the cluster pattern as formed, whereupon writing of the cluster patterns may be started again.

If the difference between the respective waveform amplitude target values on the inner and outer peripheries is set to the adequate value, the amplitude value 903-1 at a position 902-1 coincides with the amplitude value 903-2 at a position 902-2 as shown in FIG. 9(b). By continuing the operation of forming the initial pattern on this condition, it is possible to obtain the patterns at even pitches.

The operation for forming the initial pattern for the self servowrite with the magnetic disk drive according to embodiments of the present invention has been described in the foregoing. With the present embodiments, the positioning of the head after writing of a first pattern is all executed by a feedback operation using the waveform amplitudes of the pattern as written, so that it is possible to relax resolution required of the motor driver, and conditions of the dynamic range, as compared with the conventional case where the bias current for pressing the head-support mechanism to the crash stop is applied by use of open-loop control. Further, even if there exist variation in characteristics of the VCM and the crash stop, and variation in bias force, due to variation in temperature, and so forth, it is possible to provide a stable operation. Furthermore, since a circuit configuration for controlling the servo write work of the magnetic disk drive according to the present embodiments is in common with that of a control circuit for a magnetic disk drive as a common product, this can contribute to inexpensive means provided for the servo write.

What is claimed is:

1. A method for forming a servo-pattern for a magnetic disk drive provided with a magnetic disk for storing information, a magnetic head having a write element for writing information to the magnetic disk, and a read element positioned on a side of the magnetic disk, adjacent to the inner periphery, for reading the information stored in the magnetic disk, a head-support mechanism for supporting the magnetic head, an actuator for moving the magnetic head to a predetermined radial position on the magnetic disk through the intermediary of the head-support mechanism, and a crash-stop for limiting a movable range of the head-support mechanism, said method comprising the steps of:
writing a cluster pattern made up of pattern blocks, each including a burst pattern, by use of the write element, at the stage of forming an initial servo pattern by pressing the head-support mechanism to the crash-stop; and
newly writing a pattern block with the read element in states of being positioned at an inner peripheral side edge of the cluster pattern, an outer peripheral side edge thereof, and the center of two burst patterns included in the cluster pattern, respectively, thereby writing a cluster pattern having pattern blocks greater by one in numbers than the pattern blocks of the cluster pattern, wherein by sequentially changing a cluster pattern for use in positioning into a newly written cluster pattern thereafter, an operation for writing a cluster pattern is repeated, and a width of the cluster patterns is increased in stages, thereby forming the initial servo pattern for use in a propagation action.

2. The method for forming the servo-pattern according to claim 1, wherein an operation for positioning of the read element at the cluster pattern is executed by feeding back a deviation from a target value for a read waveform amplitude.

3. The method for forming the servo-pattern according to claim 1, wherein at the time of the positioning of the read element at the respective edges of the cluster pattern, a target value for a read waveform amplitude at the inner peripheral side edge of the cluster pattern differs from that at the outer peripheral side edge thereof.

4. The method for forming the servo-pattern according to claim 1, wherein at the time of the positioning of the read element at the respective edges of the cluster pattern, a target value for a read waveform amplitude is adjusted on the basis of results of measurement on a way in which bursts of a cluster pattern made up of not less than three stages of pattern blocks overlap each other.

5. The method for forming the servo-pattern according to claim 1, wherein formation of the initial servo pattern is completed when the write element writes a pattern block on the outer peripheral side of a new cluster pattern while the read element can read a pattern block on the inner peripheral side of the new cluster pattern.

6. A method for forming a servo-pattern for a magnetic disk drive provided with a magnetic disk for storing information, a magnetic head having a write element for writing information to the magnetic disk, and a read element positioned on a side of the magnetic disk, adjacent to the inner periphery, for reading the information stored in the magnetic disk, a head-support mechanism for supporting the magnetic head, an actuator for moving the magnetic head to a predetermined radial position on the magnetic disk through the intermediary of the head-support mechanism, and a crash-stop for limiting a movable range of the head-support mechanism, said method comprising:
a first step of executing positioning of the magnetic head on the inner peripheral side of the magnetic disk by pressing the head-support mechanism to the crash-stop to thereby write a first cluster pattern made up of pattern blocks, each including a burst pattern for detection of a read waveform amplitude;
a second step of moving the magnetic head toward the outer periphery of the magnetic disk to thereby write a pattern block in a first stage of a second cluster pattern with the read element in a state as positioned at the inner peripheral side edge of the first cluster pattern while writing a pattern block in a second stage of the second cluster pattern with the read element in a state as positioned at the outer peripheral side edge of the first cluster pattern; and
a third step of further moving the magnetic head toward the outer periphery of the magnetic disk to thereby write a pattern block in a first stage of a third cluster pattern with the read element in a state as positioned at inner peripheral side edge of the second cluster pattern, and writing a pattern block in a second stage of the third cluster pattern with the read element in a state as positioned at the center of two burst patterns of the second cluster pattern while writing a pattern block in a third stage of the third cluster pattern with the read element in a state as positioned at the outer peripheral side edge of the second cluster pattern, wherein the third step is repeated to thereby increase a width of the cluster patterns in stages, and the initial servo pattern for use in a propagation action is formed.

7. The method for forming the servo-pattern according to claim 6, wherein an operation for positioning of the read element at the cluster pattern is executed by feeding back a deviation from a target value for a read waveform amplitude.

8. The method for forming the servo-pattern according to claim 6, wherein at the time of the positioning of the read element at the respective edges of the cluster pattern, a target value for a read waveform amplitude at the inner peripheral side edge of the cluster pattern differs from that at the outer peripheral side edge thereof.

9. The method for forming the servo-pattern according to claim 6, wherein at the time of the positioning of the read element at the respective edges of the cluster pattern, a target value for a read waveform amplitude is adjusted on the basis of results of measurement on a way in which bursts of a cluster pattern made up of not less than three stages of pattern blocks overlap each other.

10. The method for forming the servo-pattern according to claim 6, wherein formation of the initial servo pattern is completed when the write element writes a pattern block on the outer peripheral side of a new cluster pattern while the read element can read a pattern block on the inner peripheral side of the new cluster pattern.

11. A magnetic disk drive comprising:
a magnetic disk for storing information;
a magnetic head having a write element for writing information to the magnetic disk, and a read element positioned on a side of the magnetic disk, adjacent to the inner periphery, for reading the information stored in the magnetic disk;
a head-support mechanism for supporting the magnetic head;
an actuator for moving the magnetic head to a predetermined radial position on the magnetic disk through the intermediary of the head-support mechanism;
a crash-stop for restricting a movable range of the head-support mechanism; and
a control circuit for controlling an operation of the actuator, and write/read operations of the magnetic head, wherein a cluster pattern made up of pattern blocks, each including a burst pattern, is written by use of the write element at the stage of forming an initial servo pattern by pressing the head-support mechanism to the crash-stop under control by the control circuit, a pattern block is newly written with the read element in states of being positioned at an inner peripheral side edge of the cluster pattern, an outer peripheral side edge thereof, and the center of two burst patterns included in the cluster pattern, respectively, to thereby write a cluster pattern having pattern blocks greater by one in numbers than the pattern blocks of the cluster pattern, a cluster pattern for use in positioning is sequentially changed into a newly written cluster pattern thereafter, an operation for writing the cluster pattern is repeated to thereby increase a width of the cluster patterns in stages, and the initial servo pattern for use in a propagation action is formed.

12. A magnetic disk drive according to claim 11, wherein an operation for positioning of the read element at the cluster pattern is executed by feeding back a deviation from a target value for a read waveform amplitude.

13. A magnetic disk drive according to claim 11, wherein at the time of the positioning of the read element at the respective edges of the cluster pattern, a target value for a read waveform amplitude at the inner peripheral side edge of the cluster pattern differs from that at the outer peripheral side edge thereof.

14. A magnetic disk drive according to claim 11, wherein at the time of the positioning of the read element at the respective edges of the cluster pattern, a target value for a read waveform amplitude is adjusted on the basis of results of measurement on a way in which bursts of a cluster pattern made up of not less than three stages of pattern blocks overlap each other.

15. A magnetic disk drive according to claim 11, wherein formation of the initial servo pattern is completed when the write element writes a pattern block on the outer peripheral side of a new cluster pattern while the read element can read a pattern block on the inner peripheral side of the new cluster pattern.
